(19) United States
(12) Patent Application Publication
(10) Pub. No.: US 2014/0075026 A1
(43) Pub. Date: Mar. 13, 2014

(54) CLOUD DATABASE MANAGEMENT METHOD

(71) Applicant: JEN CHANG KAO, TAOYUAN COUNTY (TW)

(72) Inventor: JEN CHANG KAO, TAOYUAN COUNTY (TW)

(73) Assignee: LUNG CHENG TECHNOLOGY LTD., TAICHUNG CITY (TW)

(21) Appl. No.: 13/613,082

(22) Filed: Sep. 13, 2012

(51) Int. Cl. G06F 17/30; G06F 15/173

(52) U.S. Cl. 709/225; 709/223

(57) ABSTRACT

A cloud database management method is applied in a cloud server system, and the cloud server system has a plurality of databases, and the method includes the following steps. A user end logs on the cloud server system via a network; the user end saves and hacks up a form file having a plurality of field information into the cloud server system; and each database in the cloud server system points to one of the field information in the firm to save the field information of the form file into a corresponding database one by one.

### FIELD OF THE INVENTION

The present invention relates to the technology of cloud information storage, more particularly to a cloud database management method capable of scatteredly storing file data.

### BACKGROUND OF THE INVENTION

As information technology advances and computer becomes popular, the digital storage technology has replaced the conventional way of recording data by paper. As the network technology blooms, the speed of uploading and downloading file data becomes increasingly higher, so that the cloud technology is developed to provide users a way of storing backup data into a database in the network space through a network platform.

However, present existing network platforms can provide a single database only for users to save uploaded file data, and thee is a risk of losing all file data once the database is damaged.

In view of the aforementioned problems, the inventor of the present invention provides a cloud database management method to scatteredly save the file data to reduce the risk of data storage.

### SUMMARY OF THE INVENTION

Therefore, it is a primary objective of the present invention to provide a cloud database management method capable of scatteredly storing file data to achieve the effect of reducing the risk of storing file data.

Another objective of the present invention is to provide a cloud database management method capable of preventing a waste of database spaces effectively.

A further objective of the present invention is to provide a cloud database management method provided for users to share information of each database at other user ends.

To achieve the foregoing objectives, the present invention provides a cloud database management method applied in a cloud server system, and the cloud server system comprises a plurality of databases, and the method comprises the following steps: A user end logs on the cloud server system via a network, wherein the cloud server system has an execution software, and the execution software pre-stores a plurality of field information provided for the user end to input data so that the execution software marks each of the field information inputted by the user end and points each of the field information to one of the databases, and each of the field information is stored into a corresponding database according to a path direction defined by the execution software.

Preferably, the execution software marks the field information inputted by the user end to define a same form content according to a determination condition, and points each of the field information to one of the databases according to the determination condition to generate a path direction.

Wherein, the execution software uses at least one of the field information as a determination condition and compares whether each database has created a form content which is the same as the determination condition, and if the execution software finds from the comparison that the same form content has been created in the database, the execution software assigns a same path direction to the same field information, and the execution software marks different field information as the information with the created form content having the same mark and generates another path direction, so that different field information of the same form content are stored into the corresponding databases respectively.

Further, the user end obtains an authorization code comprising a path direction of the field information through the execution software, and the authorization code is provided for another user end to enter through the execution software, so that the execution software retrieves the authorized field information from the corresponding database of the cloud server system according to the path direction included in the authorization code.

Preferably, the cloud server system comprises a login unit, and the login unit stores identity data of one or more user ends, and when the user end logs on the cloud, server system via a network, the user end must pass a verification of the login unit verification before obtaining an access right of the execution software.

Wherein, the identity data of the user end comprises at least one selected from the collection of a user IP address, a user name and a password. The login unit registers the identity data of a plurality of user ends simultaneously, and each user end obtains different membership services provided by the execution software according to as priority level set by the login unit.

### BRIEF DESCRIPTION OF THE DRAWINGS

FIG. 1 is a schematic block diagram of the present invention;

FIG. 2 is a flow chart of a procedure of storing information in accordance with the present invention;

FIG. 3 is a schematic block diagram of marking each field information and pointing to one of the databases in according to the present invention;

FIG. 4 is a schematic block diagram of a using status of the present invention;

FIG. 5 is a flow chart of a procedure provided for other user ends to examine the use of data of each database in accordance with the present invention; and

FIG. 6 is a schematic view of the architecture of the present invention connected to a plurality of user ends.

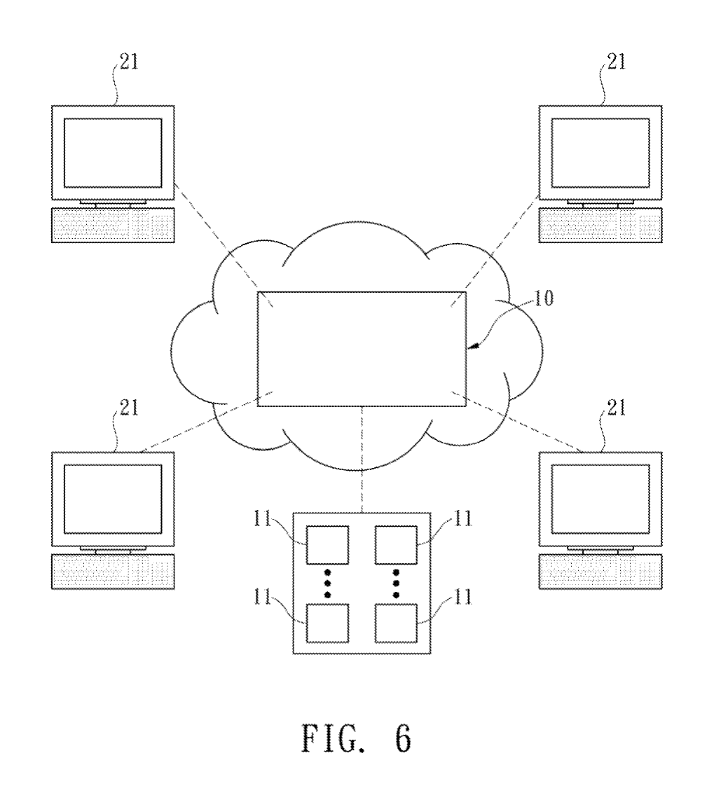

### DESCRIPTION OF THE PREFERRED EMBODIMENTS

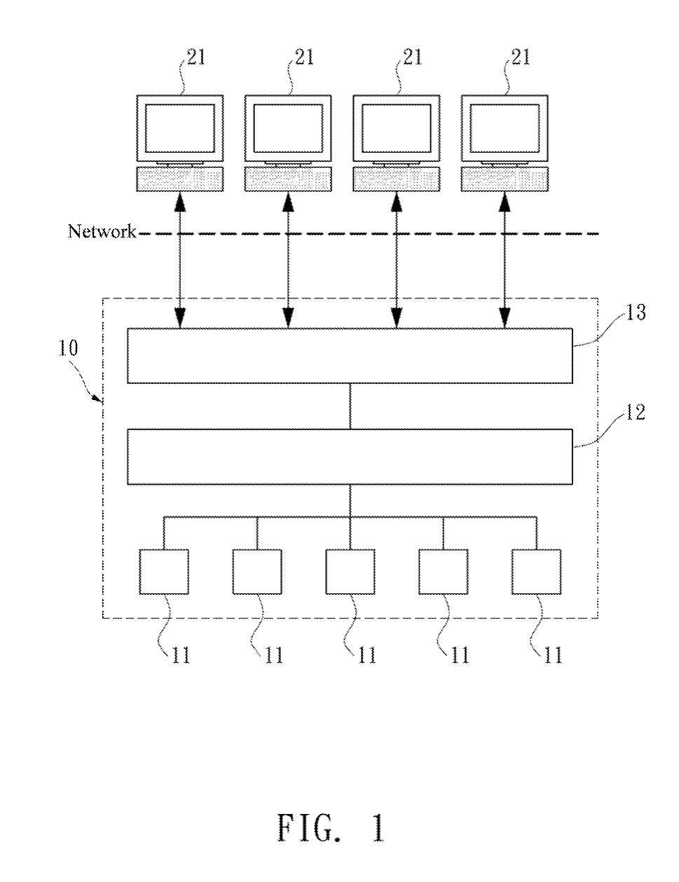

The present invention provides a cloud database management method applied in a cloud server system as shown in FIG. 1, and the cloud server system 10 comprises a plurality of databases 11, an execution software 12 interacted with each database 11, and a login unit 13 connected to the execution software 12 and provided for one or more user ends 21 to logon the cloud server system 10 via a network, wherein the login unit 13 stores identity data of one or more user ends, and identity data of the user end include at least one of a user IP address, a user name or a password, so that when the user end 21 logs on the cloud server system 10 via the network, the user end 21 must pass a verification of the login unit 13 before the user end 21 can obtain the access right of the execution software 12.

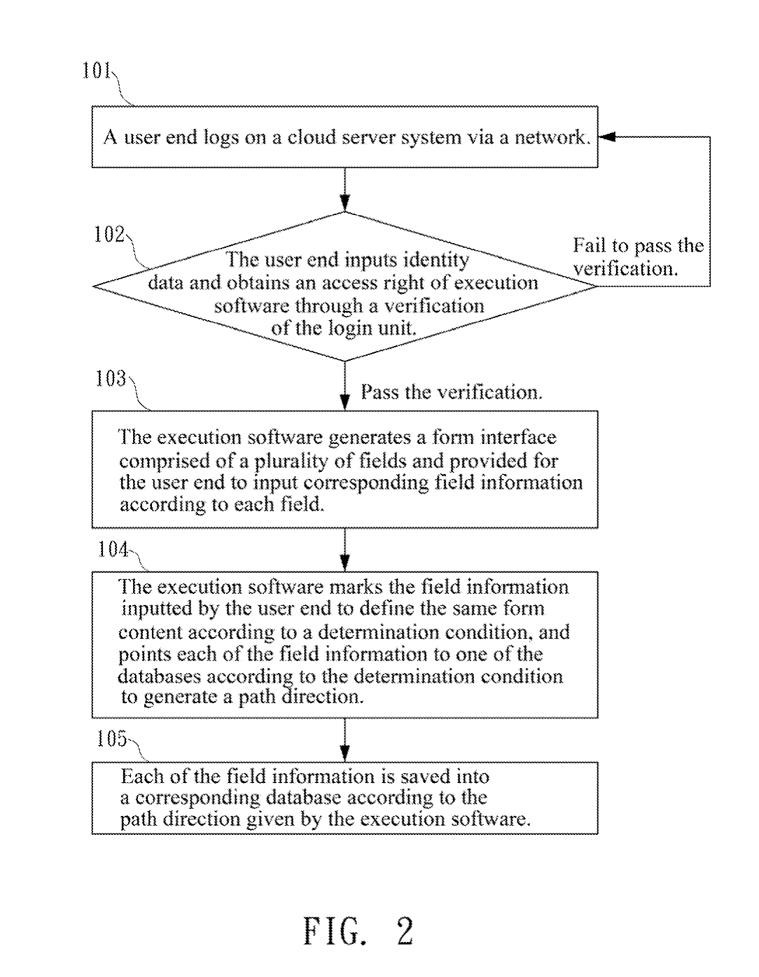

With reference to FIG. 2 for a cloud database management method of the present invention applied in the aforementioned cloud server system 10, the cloud database management method comprises the following steps:

(101): A user end 21 logs on the cloud server system 10 via a network.

(102): The user end 21 inputs identity data and obtains an access right of the execution software 12 through a verification of the login unit 13.

(103) The execution software 12 generates a form interface 31 comprised of a plurality of fields 32 and provided for the user end 21 to input corresponding field information 33 according to each field 32.

(104) The execution software 12 marks the field information 33 inputted by the user end 12 to define the same form content according to a determination condition, and points each field information 33 to one of the databases 11 according to the determination condition to generate a path direction.

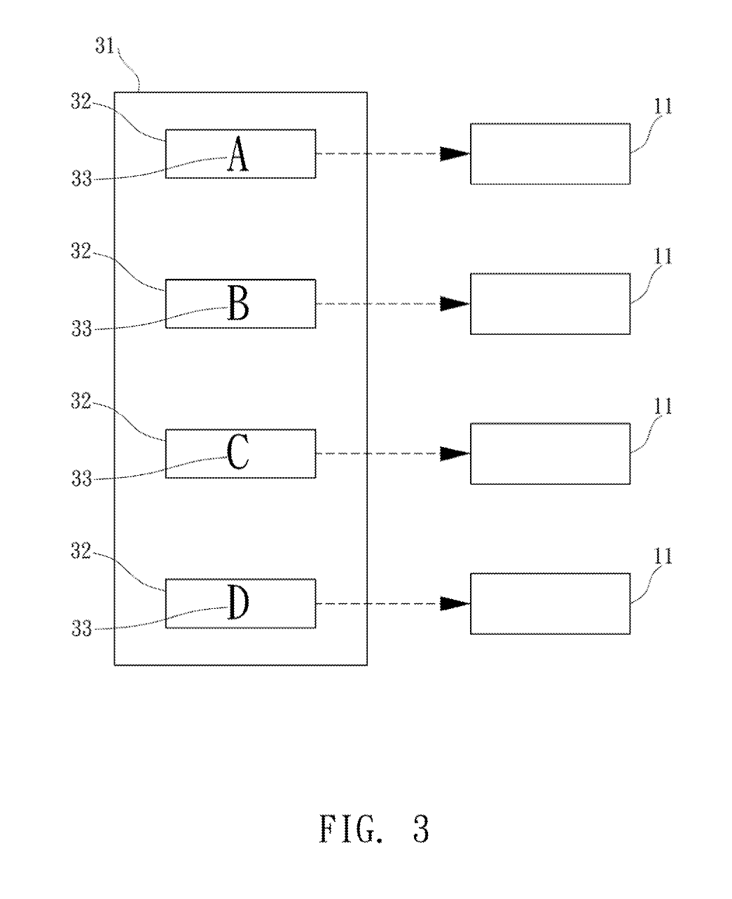

(105) Each of the field information 33 is saved into a corresponding database 11 according to the path direction given by the execution software 12 (as shown in FIG. 3).

Wherein, the execution software 12 uses at least one of the field information 33 as the determination condition and compares whether each database 11 already has created the same form content of the determination condition. If the execution software 12 finds that if the database 11 has created the same form content, the execution software 12, then the path direction of the same field information 33 is given, without the need of storing data repeatedly that occupies much database space, and different field information 33 are marked as the information having the same created form contents by the execution software 12 and another path direction is generated, and the same form content is saved into a corresponding database 11.

For example, if the form interface 31 generated by the execution software 12 is a personal basic data form including a field 32 such as name, ID number, blood type and work experience provided for the user end 21 to input corresponding field information 33. If the user end 21 inputs corresponding field information 33 and intends to save the field information 33, the execution software 12 will use the field information 33 inputted into the ID number field 32 as the determination condition to compare whether each database 11 has already created basic data of the same person.

If the comparison performed by the execution software 12 shows that basic data of the same person have not been created in the database 11, the execution software 12 will mark each field information 33 inputted by the user end 21 to define the field information 33 as the information of the same form content and will point the field information 33 to one of the databases 11, so that each field information 33 can be saved into the corresponding database 11 according to a path direction assigned by the execution software 12.

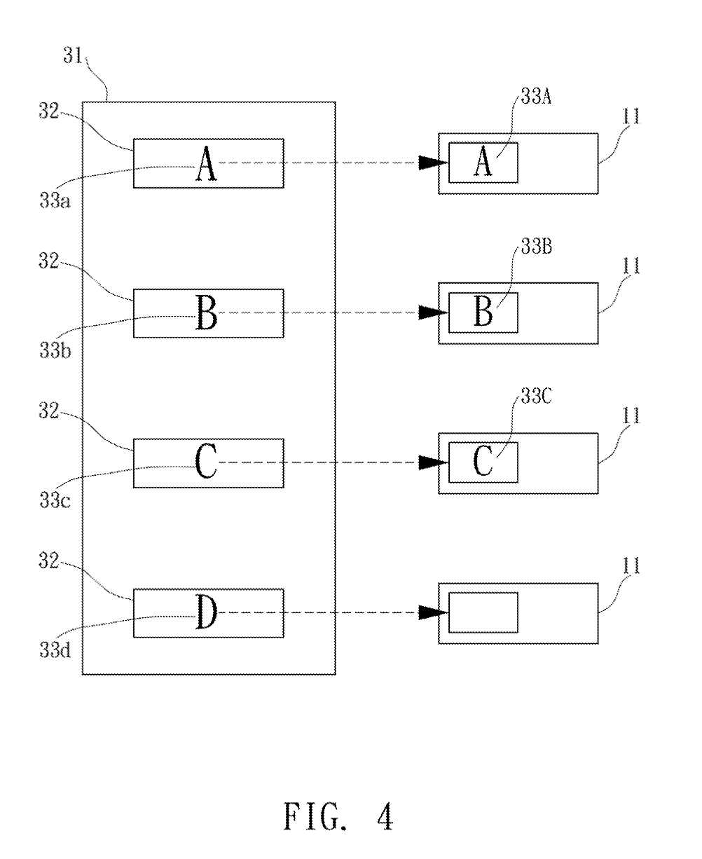

If comparison performed by the execution software 12 shows that basic data of the same person have been created in the database 11 as shown in FIG. 4, the execution software 12 will compare the field information 33A, 33B, 33C created with the same mark in each database 11 with the field information 33A, 33B, 33C inputted by the user end 21 and will mark the same field information 33A (name), 33B (ID number), 33C (blood type) inputted by the user end 21 as the information having the same path direction with the field information 33A, 33B, 33C created in each database 11, so that the basic data including the name, ID number and blood type of the same person no longer need to be stored again or occupy additional spaces of the database 11. If the basic data of the same person have not been created or are different from the field information 33D (work experience) in the database 11, then the execution software 12 will mark the basic data as the created basic data of the same person, and then will generate another path direction to save different field information 33D of basic data of the same person into a corresponding database 11.

The present invention can save the field information 33 inputted according to each field 32 through the execution software 12 by the user end 21 into the corresponding database 11, such that even if one of the databases 11 is damaged, at most a single piece of the corresponding field information 33 is destroyed, and the whole field information will not be lost, so as to achieve the effect of scattering the risk of information storage. Further, the determination condition is used to compare whether each database 11 has created the same form content, so that the field information 33 with the same form content have the same path direction, and it no longer needs to save the data repeatedly in order to avoid wasting spaces of the database 11 unnecessarily.

In addition, the user end 21 can obtain an authorization code (or key) comprising the path direction of a field information 33 through the execution software 12, such that after another user end can enter the authorization code (or key) through the execution software 12, the other user end can retrieve the authorized field information 33 from the corresponding database 11 of the cloud server system 10 through the execution software 12 according to the path direction contained in the authorization code.

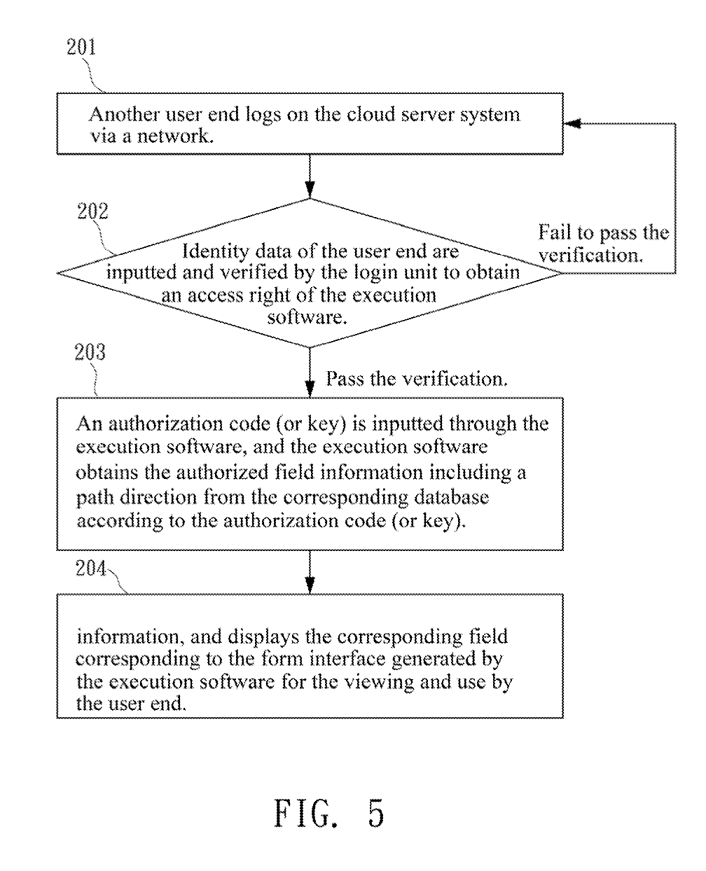

Therefore, if the other user end 21 wants to examine the using data stored in each database from the cloud server system 10 of the present invention as shown in FIG. 5, the procedure comprises the following steps:

(201): Another user end 21 logs on the cloud server system 10 via a network.

(202): Identity data of the user end 21 are inputted and verified by the login unit 13 to obtain an access right of the execution software 12.

(203): An authorization code (or key) is inputted through the execution software 12, and the execution software 12 obtains the authorized field information 33 including a path direction from the corresponding database 11 according to the authorization code (or key).

(204): The execution software 12 compiles the retrieved field information 33, and displays the corresponding field 33 corresponding to the form interface 31 generated by the execution software 12 for the viewing and use by the user end 21.

In summation of the description above, the present invention uses the login unit 13 to register a plurality at user data simultaneously, and each user end 21 can obtain different membership services provided by the execution software 12 from the cloud server system 10 according to the priority level set by the login unit 13, and the level of using information uploaded (or announced) by a registered user end 21 according to different priority levels. In addition, a mechanism for sharing the authorization code is provided for other user ends to share the information stored in each database (as shown in Ha 6), so as to achieve the effects of corporate link and resource sharing.

What is claimed is:

1. A cloud database management method, applied in a cloud, server system, and the cloud server system comprising a plurality of databases, and the method comprising the steps of: a user end logging on the cloud server system via a network, and the cloud server system having execution software, and the execution software pre-storing a plurality of field information provided for the user end to input data, so that the execution software marks each field information inputted by the user end and points each field information to one of the databases, and each of the field information is stored into a corresponding database according to a path direction defined by the execution software.

2. The cloud database management method of claim 1, wherein the execution software marks the field information inputted by the user end to define a same form content according to a determination condition, and points each field information to one of the databases according to the determination condition to generate a path direction.

3. The cloud database management method of claim 2, wherein the execution software uses at least one of the field information as a determination condition and compares whether each database has created a form content which is the same as the determination condition, and if the execution software finds from the comparison that the same thrust content has been created in the database, the execution software assigns a same path direction to the same field information, and the execution software marks different field information as the information with the created form content having the same mark and generates another path direction, so that different field information of the same form content are stored into the corresponding databases respectively.

4. The cloud database management method of claim 1, wherein the user end obtains an authorization code comprising a path direction of the field information through the execution software, and the authorization code is provided for another user end to enter through the execution software, so that the execution software retrieves the authorized field information from the corresponding database of the cloud server system according to the path direction included in the authorization code.

5. The cloud database management method of claim 1, wherein the cloud server system comprises a login unit, and the login unit stores identity data of one or user ends, and when the user end logs on the cloud server system via a network, the user end must pass a verification of the login unit verification before obtaining an access right of the execution software.

6. The cloud database management method of claim 5, wherein the identity data of the user end comprises at least one selected from the collection of a user IP address, a user name and a password.

7. The cloud database management method of claim 5, wherein the login unit registers the identity data of a plurality of user ends simultaneously, and each user end obtains different membership services provided by the execution software according to a priority level set by the login unit.
